(19) United States
(12) Patent Application Publication
(10) Pub. No.: US 2025/0091782 A1
(43) Pub. Date: Mar. 20, 2025

(54) Fluid Transfer Device

(71) Applicants: Brandon Bronson, Clinton, UT (US); Denton Bronson, Clinton, UT (US)

(72) Inventors: Brandon Bronson, Clinton, UT (US); Denton Bronson, Clinton, UT (US)

(21) Appl. No.: 18/414,565

(22) Filed: Jan. 17, 2024

Related U.S. Application Data
(60) Provisional application No. 63/583,663, filed on Sep. 19, 2023.

(51) Int. Cl. B65D 71/50; B65D 21/02

(52) U.S. Cl. CPC B65D 71/502; B65D 21/0224

(57) ABSTRACT

The disclosed fluid transfer device is a multipurpose, efficient way to transfer viscous fluid from one container to another. The fluid transfer device comprises a body component that is configured in a cylindrical shape with opposing ends sized large enough to accept the threaded connection from various fluid-holding containers. The body component would be of various lengths and diameters to allow for the mating to different bottles like those containing ketchup, ranch dressing, shampoo, ointments, creams, lotions, and numerous other viscous fluids. The body component also comprises a center section with threaded features to allow the user to thread the fluid transfer device onto fluid containers. Thus, each fluid transfer device functions as a suitable way of allowing the complete and clean transfer of viscous fluids from one container to another container.

### CROSS-REFERENCE TO RELATED APPLICATION

The present application claims priority to, and the benefit of, U.S. Provisional Application No. 63/583,663, which was filed on Sep. 19, 2023, and is incorporated herein by reference in its entirety.

### FIELD OF THE INVENTION

The present invention relates generally to the field of fluid transfer devices. More specifically, the present invention relates to a simple and efficient way to transfer viscous fluids from one bottle to another bottle to prevent waste. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to the transfer of viscous products stored in bottles like ketchup, mayonnaise, shampoo, conditioner, lotion, and numerous other items. It can be difficult to fully remove viscous fluids from one bottle to another bottle. People often leave small amounts of product in the container because it is frustrating to try and squeeze out the last little bit inside. However, throwing away usable products is ultimately a waste of money.

Further, the use of funnels to transfer fluids from one container to another is well-known in the art. However, funnels and other prior art fluid transfer devices waste fluid by allowing some of the fluid to stick to the sides of the funnel, which can allow for contaminants to enter the new container at the time of transfer. Accordingly, it would be desirable to have the ability to transfer viscous fluids without loss of fluid and without contaminants entering the new container. Thus, a device that allows a container to drain viscous fluid into another container over a span of time, to allow for all the fluid to transfer is desirable.

Accordingly, there is a demand for an improved fluid transfer device that can transfer viscous fluid efficiently and completely without allowing contamination into the fluid. Further, the device provides users with a bottle cap assembly that enables fluid to be transferred from one bottle to another. Further, the fluid transfer device prevents viscous products like ketchup, ranch dressing, shampoo, ointments, creams, lotions, and numerous other items from going to waste in the bottom of a bottle greatly reducing waste and ultimately saving money.

Therefore, there exists a long-felt need in the art for a fluid transfer device that provides users with a means for transferring viscous fluids from one container to another. There is also a long-felt need in the art for a fluid transfer device that features a sealed connection from one container to another. Further, there is a long-felt need in the art for a fluid transfer device that enables users to allow for a complete transfer of fluid without the worry of contamination entering the container. Further, there is a long-felt need in the art for a fluid transfer device that prevents any loss of fluid to save money, reduce waste, and keep containers clean.

The subject matter disclosed and claimed herein, in one embodiment thereof, comprises a fluid transfer device. The device is a unique bottle cap assembly designed to transfer viscous fluid from one container to another. The fluid transfer device comprises a body component that is configured in a cylindrical shape with opposing ends sized large enough to accept the threaded connection from various fluid-holding containers. The body component would be of various lengths and diameters to allow for the mating to different bottles like those containing ketchup, ranch dressing, shampoo, ointments, creams, lotions, and numerous other viscous fluids. The body component also comprises a center section with threaded features to allow the user to thread the fluid transfer device onto fluid containers. Further, there will be a through hole in the middle of the body component, allowing for easy transfer of fluid from one bottle to the other, when the body component is secured to two different bottles, end to end. Specifically, users place a bottle on a flat surface and connect a second bottle vertically to the first via the fluid transfer device. The second bottle remains upside-down so that the product drains into the first bottle. Thus, each fluid transfer device functions as a suitable way of allowing the complete and clean transfer of viscous fluids from one container to another container.

In this manner, the fluid transfer device of the present invention accomplishes all of the foregoing objectives and provides users with a device that provides efficient, complete, and clean transfer of fluids from one container to another container.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fluid transfer device. The device is a unique bottle cap assembly designed to transfer viscous fluid from one container to another. The fluid transfer device comprises a body component that is configured in a cylindrical shape with opposing ends sized large enough to accept the threaded connection from various fluid-holding containers. The body component would be of various lengths and diameters to allow for the mating of different containers, to transfer viscous fluid from one container to the other container. Specifically, the first container would be connected to the second container by use of the fluid transfer device, positioning the second container upside down to allow gravity to pull viscous fluid into the first container. The body component also comprises a center section with threaded features to allow the user to thread the fluid transfer device onto the first and second fluid containers. The body component also comprises a through hole in the center to allow for easy transfer of viscous fluids. Thus, each fluid transfer device functions as a suitable way of allowing the complete and clean transfer of viscous fluids from one container to another container.

In one embodiment, the fluid transfer device comprises a body component, a gripping element, first and second coupling elements, and first and second internal threads. The body component is generally cylindrical in shape with first and second opposing ends. The diameter and length of the body component is variable to fit onto variable-sized fluid containers. The first and second opposing ends incorporate first and second coupling elements to allow the body component to mate with first and second fluid containers. The body component also has an open aperture or through hole to allow viscous fluid to flow completely from the first end to the second end.

In one embodiment, the body component is manufactured from polystyrene, polyethylene, PVC, or any other suitable material known in the art.

In one embodiment, the fluid transfer device comprises a body component that is generally cylindrical in shape with opposing first and second ends. The opposing first and second ends incorporate first and second coupling elements, which are preferably cylindrical in shape and provided with internal threads. The pitch and effective internal diameter of the internal threads is such as to make the same detachably engageable with the external threads of the first and second fluid containers.

In one embodiment, the body component comprises a valve component within the through hole. The valve component acts to control the flow of the viscous fluid between the first and second fluid containers. In this embodiment, the valve component is a twist valve that can be twisted open or twisted close.

In one embodiment, a body component comprises of a plurality of gripping elements around the circumference of the body component. The gripping elements are ridges or V-shaped cuts to allow for the application of torque to the body component without the user's hands slipping. The gripping elements can span the body component from the opposing first end to the second end running axially along the length of the body component.

In one embodiment, the body component is configured with a plurality of vents for allowing trapped air to exit the device. While the plurality of air vents have been described as forming an exit for entrapped air, whether or not they perform this function will depend upon the constituency, the consistency, and the amount of viscous fluid being transferred, because under many conditions air will be entering through the plurality of vents to travel up into the upper or second fluid container to take the place of the viscous fluid, as the same moves downwardly. Specifically, the plurality of vents are openings in the side wall of the body component positioned axially and, in a form, to assure no viscous fluid can escape with the escaping air.

In one embodiment, the first and second internal threads can be truncated threads, allowing the device to be pushed quickly onto the first and second fluid containers, without twisting. Typically, the device is unthreaded for removal, but attachment can be done via pushing the device onto the opening of the fluid containers. The truncated threads allow for quick and easy insertion when needed, to prevent the viscous fluid from the fluid containers from escaping during insertion of the device.

In use, the fluid transfer device may be arranged in a number of ways. Thus, for example, it is feasible to connect the first coupling element upon the neck of a first fluid container until the neck takes the position over the second fluid container. The body component and the first fluid container are then turned upside down and connected to the second fluid container. The body component with the first fluid container is then threaded onto the second fluid container, allowing viscous fluid to transfer from the first fluid container to the second fluid container, or the first and second fluid containers can be switched in position, allowing the second fluid container to be positioned over top of the first fluid container.

In one embodiment, the fluid transfer device can be utilized with any suitable fluid container as is known in the art.

In yet another embodiment, the fluid transfer device comprises a plurality of indicia.

In yet another embodiment, a method of transferring viscous fluid from one container to another container is disclosed. The method includes the steps of providing a fluid transfer device comprising a body component with threaded ends and a through hole in the center. The method also comprises removing the cap on a first fluid container and attaching the threaded end of the fluid transfer device to the first fluid container. Further, the method comprises removing the cap on a second fluid container and positioning the second fluid container over the first fluid container. The method comprises securing the fluid transfer device to the second fluid container. Also, the method comprises positioning the second fluid container upside-down over the first fluid container to allow the viscous fluid to flow through the device. Finally, the method comprises allowing the viscous fluid to flow from the second fluid container through the device to the first fluid container.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the fluid transfer device of the present invention showing the device applied to various fluid containers in accordance with the disclosed architecture;

FIG. 2 illustrates a front perspective view of one embodiment of the fluid transfer device of the present invention showing how the device is applied to a fluid container after the container's cap is removed in accordance with the disclosed architecture;

FIG. 3 illustrates a front perspective view of one embodiment of the fluid transfer device of the present invention showing how one container is connected to another container with the device in accordance with the disclosed architecture;

FIG. 4 illustrates a front perspective view of one embodiment of the fluid transfer device of the present invention in use showing how fluid is transferred from one container to another container in accordance with the disclosed architecture;

FIG. 5 illustrates a front perspective view of one embodiment of the fluid transfer device of the present invention in use with the complete transfer of the fluid from one container to another container in accordance with the disclosed architecture;

FIG. 6 illustrates a side perspective view of one embodiment of the fluid transfer device of the present invention showing the twist open and close valve for easy transfer of fluid from one container to another in accordance with the disclosed architecture; and

FIG. 7 illustrates a flowchart showing the method of transferring viscous fluid from one container to another container in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a fluid transfer device that provides users with a means for transferring viscous fluids from one container to another. There is also a long-felt need in the art for a fluid transfer device that features a sealed connection from one container to another. Further, there is a long-felt need in the art for a fluid transfer device that enables users to completely transfer fluid without the worry of contamination entering the container. Further, there is a long-felt need in the art for a fluid transfer device that prevents any loss of fluid to save money, prevent waste, and keep containers clean.

The present invention, in one exemplary embodiment, provides a fluid transfer device that is a unique bottle cap assembly designed so viscous fluid products can easily be transferred from one container to another. The fluid transfer device comprises a body component that is configured in a cylindrical shape with opposing ends sized large enough to accept the threaded connection from various fluid-holding containers. The body component also comprises a center section with threaded features to allow the user to thread the fluid transfer device onto fluid containers. The body component also comprises a through hole in the center to allow for easy fluid transfer. Thus, each fluid transfer device functions as a suitable way of allowing the complete and clean transfer of viscous fluids from one container to another container. The present invention also includes a novel method of transferring viscous fluid from one container to another container. The method includes the steps of providing a fluid transfer device comprising a body component with threaded ends and a through hole in the center. The method also comprises removing the cap on a first fluid container and attaching the threaded end of the fluid transfer device to the first fluid container. Further, the method comprises removing the cap on a second fluid container and positioning the second fluid container over the first fluid container. The method comprises securing the fluid transfer device to the second fluid container. Also, the method comprises positioning the second fluid container upside-down over the first fluid container to allow the viscous fluid to flow through the device. Finally, the method comprises allowing the viscous fluid to flow from the second fluid container through the device to the first fluid container.

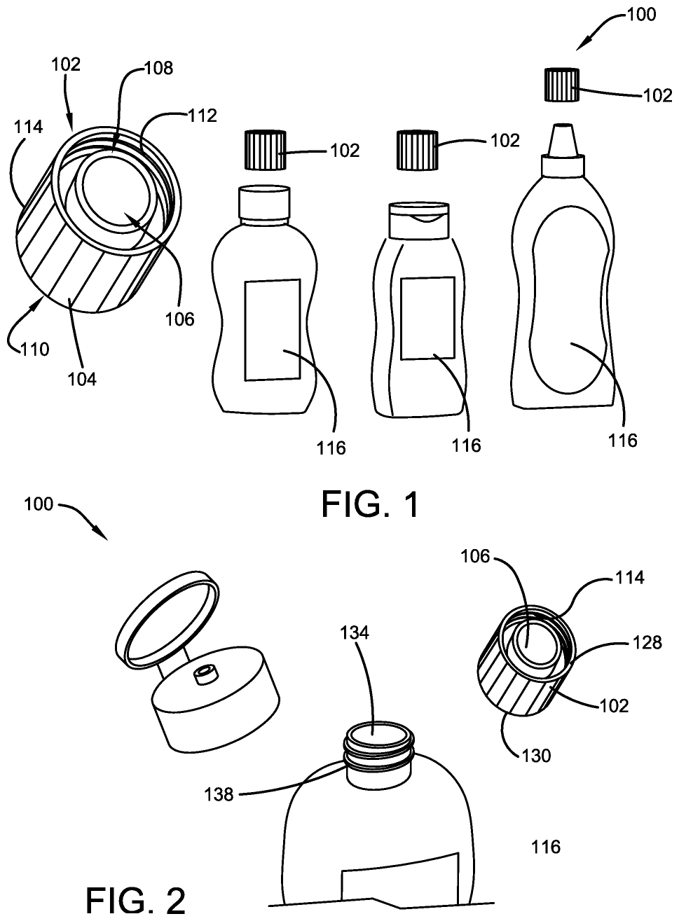

Referring initially to the drawings, FIG. 1 illustrates a perspective view of one embodiment of the fluid transfer device 100 of the present invention. The fluid transfer device 100 is an improved fluid transfer device 100 that provides a user with a unique bottle cap assembly designed so viscous fluid products can be easily transferred from container to container. Specifically, the fluid transfer device 100 comprises a body component 102 of suitable shape and size. The body component 102 comprises a gripping element 104, with first 128 and second 130 opposing ends. Each opposing end 128 and 130 comprises a first coupling element 108 and first internal threads 112 and the opposing end 130 comprises a second coupling element 110 and second internal threads 114. Further, the body component 102 has an open aperture 106 or through hole to allow viscous fluid 126 to flow completely from the first end 128 to the second end 130.

Generally, the shape and size of the body component 102 is variable to allow it to fit onto the appropriate fluid containers 116, 118. Thus, fluid containers 116, 118 of variable sizes and shapes can utilize the disclosed device 100. Specifically, fluid containers 116, 118 such as those containing ketchup, mustard, ranch dressing, condiments, shampoo, conditioner, beauty products, ointments, creams, lotions, baby products, etc., and any other suitable viscous fluid-containing containers as is known in the art.

Further, the fluid transfer device 100 comprises a body component 102 that is configured in a cylindrical shape but can be any suitable shape as is known in the art, depending on the needs and/or wants of a user and/or the size and shape of the fluid containers to be connected. The opposing first 128 and second 130 ends of the body component 102 are sized and shaped to accept and be connected to the ends 122, 132 of various fluid-holding containers 116, 118. The mating of different containers 116, 118, allows for the transfer of viscous fluid 126 from one fluid container 116 to the second fluid container 118. Specifically, the first fluid container 116 would be connected to the second fluid container 118 by use of the fluid transfer device 100, positioning the second container 118 upside down to allow gravity to pull the viscous fluid 126 into the first container 116. Thus, each fluid transfer device 100 functions as a suitable way of allowing the complete and clean transfer of viscous fluids 126 from a second container 118 to a first container 116.

Additionally, the first 128 and second 130 opposing ends of the body component 102 incorporate first 108 and second 110 coupling elements to allow the body component 102 to mate with first 116 and second 118 fluid containers and be releasably secured. Thus, the first 108 and second 110 coupling elements allow the device to be secured and removed, as needed from any suitable fluid container 116, 118 as is known in the art. Further, any suitable coupling means can be utilized as is known in the art, such as threads, snap fit, etc., depending on the needs and/or wants of a user and the size of the opening 134, 136 of the fluid containers 116, 118.

Typically, the first 108 and second 110 coupling elements are preferably cylindrical in shape and provided with first 112 and second 114 internal threads for releasably securing the body component 102 to the openings 134, 136 of the fluid containers 116, 118. Specifically, the pitch and effective internal diameter of the internal threads 112, 114 is such as to make the same detachably engageable with the external threads 138, 140 of the first 116 and second 118 fluid containers.

In one embodiment, the first 112 and second 114 internal threads can be truncated threads 142, allowing the device 100 to be pushed quickly onto the first 116 and second 118 fluid containers, without twisting or threading on. Typically, the device 100 is unthreaded for removal, but attachment can be done via pushing the device 100 onto the opening 134, 136 of the fluid containers 116, 118. The truncated threads 142 allow for quick and easy insertion when needed, to prevent the viscous fluid 126 from the fluid containers 116, 118 from escaping during insertion of the device 100.

As shown in FIGS. 2 and 6, the body component 102 has an open aperture 106 or through hole to allow viscous fluid 126 to flow completely from the first end 128 to the second end 130 of the body component 102. The through hole 106 can be any suitable size and shape, as long as the through hole 106 allows the viscous fluid 126 to flow easily and unencumbered from a second fluid container 118 to the first fluid container 116. Typically, the through hole 106 is large enough to completely encompass the entire opening 134, 136 of the first 116 or second 118 fluid containers.

In one embodiment, shown in FIG. 6, the through hole 106 comprises a valve component 144. The valve component 144 acts to control the flow of the viscous fluid 126 between the first 116 and second 118 fluid containers. In this embodiment, the valve component 144 is a twist valve that can be manually twisted open or twisted close, as needed. The valve component 144 can prevent too much viscous fluid 126 from entering the first fluid container 116 all at once and causing leaks, or the valve component 144 can prevent too little viscous fluid 126 from entering the first fluid container 116. The valve component 144 allows a user to open the valve 144 completely, exposing the entire through hole 106, or to open the valve 144 partially, exposing only a part of the through hole 106, depending on the needs and/or wants of a user and the amount of viscous fluid 126 intended to be released.

Further, the body component 102 comprises a plurality of gripping elements 104 positioned around the circumference of the body component 102. The gripping elements 104 are ridges or V-shaped cuts to allow for the application of torque to the body component 102 without the user's hands slipping, but can be any suitable gripping means, design, or texture as is known in the art. The gripping elements 104 can span the body component 102 from the opposing first end 128 to the second end 130, running axially along the length of the body component 102 or can be located at a few distinct positions on the body component 102, depending on the wants and/or needs of a user. Additionally, the fluid transfer device 100 is removably attached to the first 116 and second 118 fluid containers by way of the first 108 and second 110 coupling elements (i.e., the internal threads 112, 114). Thus, the user uses the gripping elements 104 to allow the user to easily torque the fluid transfer device 100 to assure the device 100 will not fall off of the first 116 or second 118 fluid containers.

In one embodiment, the body component 102 is configured with a plurality of vents 124 for allowing trapped air to exit the device 100. While the plurality of air vents 124 have been described as forming an exit for entrapped air, whether or not they perform this function will depend upon the constituency, the consistency, and the amount of viscous fluid 126 being transferred, because under many conditions air will be entering through the plurality of vents 124 (not leaving), to travel up into the upper or second fluid container 118 to take the place of the viscous fluid 126, as the same moves downwardly. Specifically, the plurality of vents 124 are openings in the side wall of the body component 102 positioned axially and, in a form, to assure no viscous fluid 126 can escape with the escaping air. The plurality of vents 124 can be any suitable shape and size as is known in the art, as long as they act to expel trapped air and/or allow air to enter, as needed.

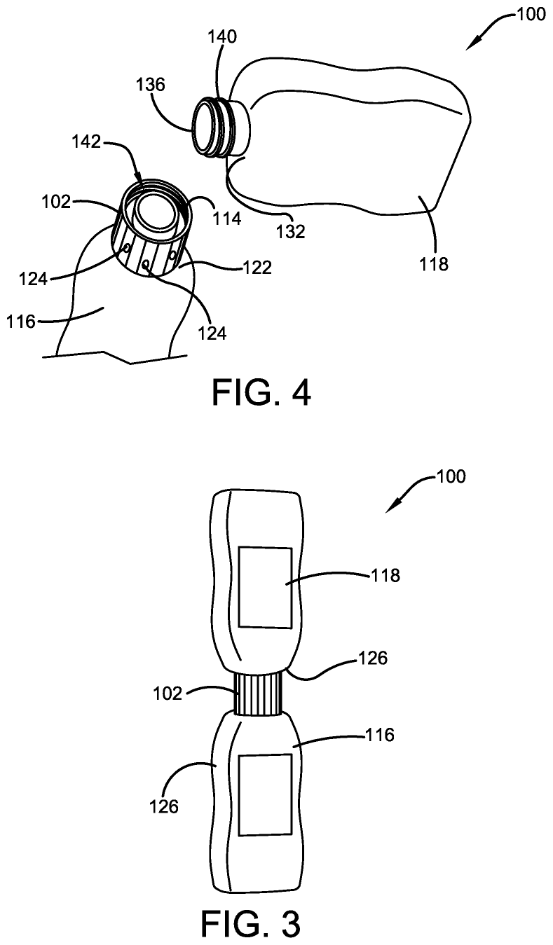

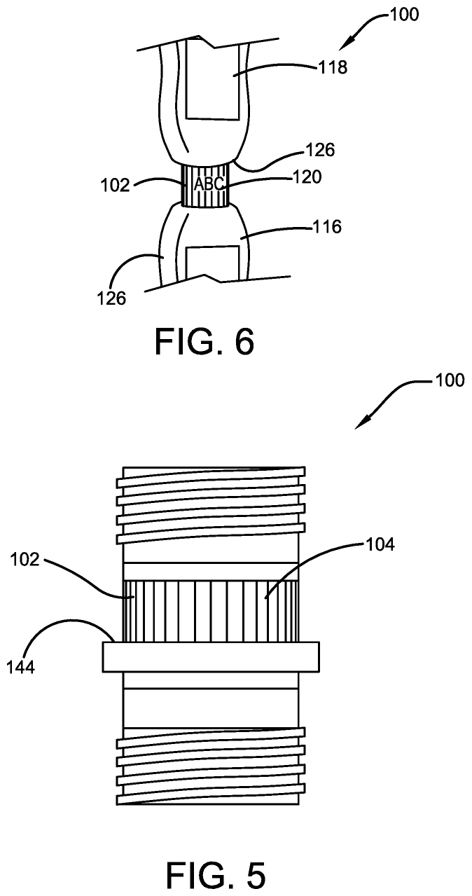

As shown in FIGS. 3-5, the first fluid container 116 is secured to the body component 102 and the second fluid container 118 is positioned over the first fluid container 116 with the body component 102 removably attached to the first fluid container's external threads 138. The second fluid container 118 is then turned over and removably attached to the second internal threads 114 of the body component 102. Once in position, the second fluid container 118 remains upside down over the first fluid container 116, such that the entirety of the remaining viscous fluid 126 can flow through the body component 102 via the open aperture 106.

In use, the fluid transfer device 100 may be arranged in a number of ways. Thus, for example, it is feasible to connect the first coupling element 108 upon the external threads 138 of a first fluid container 116. The second fluid container 118 is then turned upside down and connected to the first fluid container 116 via the body component 102. The body component 102 with the first fluid container 116 attached, is then threaded onto the second fluid container 118 via the external threads 140 of the second fluid container 118 mating with the internal threads 114 of the body component 102. Thus, allowing viscous fluid 126 to transfer from the second fluid container 118 to the first fluid container 116, or the first 116 and second 118 fluid containers can be switched in position, allowing the second fluid container 118 to be positioned over top of the first fluid container 116.

In one embodiment, the fluid transfer device 100 is made of a lightweight, durable material such as plastic or the like and manufactured through common extruding and molding processes. Specifically, the device 100 can be manufactured from heat-scalable plastic or polymers, such as polypropylene, acrylonitrile-butadiene-styrene (ABS), polyethylene, polyethylene terephthalate, polyvinyl chloride, polystyrene, etc. Generally, the fluid transfer device 100 is also manufactured from a material that is water resistant or waterproof, or the body component 102 comprises a coating that is water resistant or waterproof. Furthermore, the device 100 can be made of antibacterial or antimicrobial material or the body component 102 comprises a coating that is antibacterial or antimicrobial.

In one embodiment, the fluid transfer device 100 comprises a plurality of indicia 120. Specifically, the body component 102 of the device 100 may include advertising, a trademark, or other letters, designs, or characters, printed, painted, stamped, or integrated into the body component 102, or any other indicia 120 as is known in the art. Further, any suitable indicia 120 as is known in the art can be included, such as, but not limited to, patterns, logos, emblems, images, symbols, designs, letters, words, characters, animals, advertisements, brands, etc., that may or may not be a viscous fluid, fluid container, or brand related.

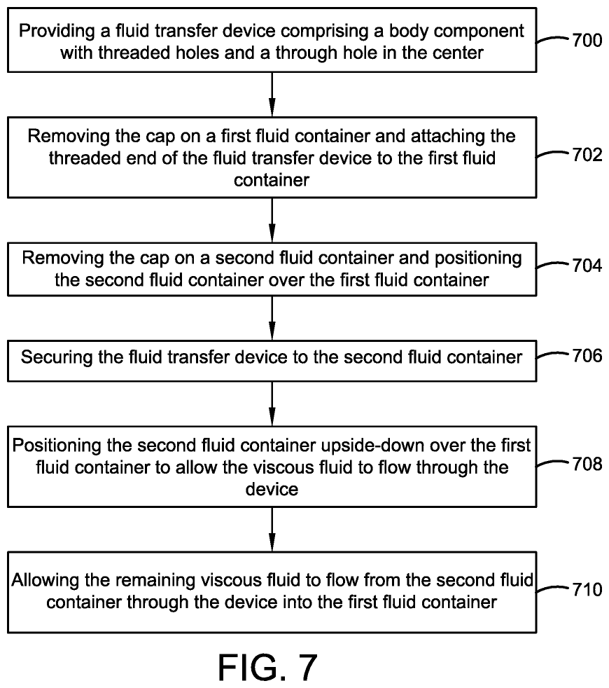

FIG. 7 illustrates a flowchart of the method of transferring viscous fluid from one container to another container. The method includes the steps of at 700, providing a fluid transfer device comprising a body component with threaded ends and a through hole in the center. The method also comprises at 702, removing the cap on a first fluid container and attaching the threaded end of the fluid transfer device to the first fluid container. Further, the method comprises at 704, removing the cap on a second fluid container and positioning the second fluid container over the first fluid container. The method comprises at 706, securing the fluid transfer device to the second fluid container. Also, the method comprises at 708, positioning the second fluid container upside-down over the first fluid container to allow the viscous fluid to flow through the device. Finally, the method comprises at 710, allowing the remaining viscous fluid to flow from the second fluid container through the device to the first fluid container.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “fluid transfer device”, “fluid device”, “transfer device”, and “device” are interchangeable and refer to the fluid transfer device 100 of the present invention.

Notwithstanding the foregoing, the fluid transfer device 100 of the present invention can be of any suitable size and configuration as is known in the art without affecting the overall concept of the invention, provided that it accomplishes the above-stated objectives. One of ordinary skill in the art will appreciate that the fluid transfer device 100 as shown in FIGS. 1-7 is for illustrative purposes only, and that many other sizes and shapes of the fluid transfer device 100 are well within the scope of the present disclosure. Although the dimensions of the fluid transfer device 100 are important design parameters for user convenience, the fluid transfer device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fluid transfer device that provides a user with a means such that viscous fluids can be easily transferred from container to container, the fluid transfer device comprising:
a body component;
wherein the body component comprises opposing first end and second end;
wherein the opposing first end and second end comprise a first coupling element and a second coupling element;
wherein the first coupling element releasably secures to a first fluid container;
wherein the second coupling element releasably secured to a second fluid container;
wherein the body component comprises an open aperture in a middle; and
wherein viscous fluid from the second fluid container completely flows into the first fluid container through the open aperture.

2. The fluid transfer device of claim 1, wherein the first and second fluid containers comprise ketchup, mustard, ranch dressing, condiments, shampoo, conditioner, beauty products, ointments, creams, lotions, or baby products fluid containers.

3. The fluid transfer device of claim 2, wherein the body component is configured in a cylindrical shape.

4. The fluid transfer device of claim 3, wherein the first and second coupling elements comprise first and second internal threads for releasably securing the body component to the first and second fluid containers.

5. The fluid transfer device of claim 4, wherein the first and second internal threads mate with first and second external threads of the first and second fluid containers.

6. The fluid transfer device of claim 5, wherein the first and second internal threads can be truncated threads, allowing the body component to be pushed quickly onto the first and second fluid containers, without twisting or threading on.

7. The fluid transfer device of claim 5, wherein the open aperture is sized to completely encompass entire opening of the first or second fluid containers.

8. The fluid transfer device of claim 7, wherein the open aperture comprises a valve component that controls flow of the viscous fluid from the second fluid container to the first fluid container.

9. The fluid transfer device of claim 8, wherein the valve component is a twist valve that can be manually twisted open or twisted close, as needed.

10. The fluid transfer device of claim 9, wherein the body component comprises a plurality of gripping elements positioned around a circumference of the body component.

11. The fluid transfer device of claim 10, wherein the plurality of gripping elements are ridges or V-shaped cuts that run axially along a length of the body component.

12. The fluid transfer device of claim 11, wherein the body component is configured with a plurality of vents for allowing trapped air to exit the fluid transfer device.

13. The fluid transfer device of claim 12, wherein the plurality of vents are openings in a side wall of the body component, positioned axially to assure no viscous fluid can escape with any escaping air.

14. A fluid transfer device that provides a user with a means such that viscous fluids can be easily transferred from container to container, the fluid transfer device comprising:
a body component configured in a cylindrical shape;
wherein the body component comprises opposing first end and second end;
wherein the opposing first end and second end comprise a first coupling element and a second coupling element;
wherein the first and second coupling elements comprise first and second internal threads for releasably securing the body component to a first and second fluid container;
wherein the first and second internal threads mate with first and second external threads of the first and second fluid containers;
wherein the body component comprises an open aperture in a middle, sized to completely encompass an entire opening of the first or second fluid containers;
wherein the open aperture comprises a twist valve component that controls flow of the viscous fluid from the second fluid container to the first fluid container by manually twisting the twist valve component open and closed;
wherein the second fluid container is turned upside down and connected to the first fluid container via the body component; and
further wherein viscous fluid from the second fluid container completely flows into the first fluid container through the open aperture.

15. The fluid transfer device of claim 14, wherein the body component comprises a plurality of gripping elements positioned around a circumference of the body component.

16. The fluid transfer device of claim 15, wherein the plurality of gripping elements are ridges or V-shaped cuts that run axially along a length of the body component.

17. The fluid transfer device of claim 14, wherein the body component is configured with a plurality of vents for allowing trapped air to exit the fluid transfer device.

18. The fluid transfer device of claim 17, wherein the plurality of vents are openings in a side wall of the body component, positioned axially to assure no viscous fluid can escape with any escaping air.

19. The fluid transfer device of claim 14 further comprising a plurality of indicia.

20. A method of transferring viscous fluid from one container to another container, the method comprising the following steps:
providing a fluid transfer device comprising a body component with threaded ends and a through hole in the center;
removing the cap on a first fluid container and attaching the threaded end of the fluid transfer device to the first fluid container;
removing the cap on a second fluid container and positioning the second fluid container over the first fluid container;
securing the fluid transfer device to the second fluid container;
positioning the second fluid container upside-down over the first fluid container to allow the viscous fluid to flow through the device; and
allowing the remaining viscous fluid to flow from the second fluid container through the device to the first fluid container.
